(19) United States
(12) Patent Application Publication
(10) Pub. No.: US 2010/0265586 A1
(43) Pub. Date: Oct. 21, 2010

(54) PHOTONIC DEVICE FOR SPATIAL FILTERING WITH NARROW ANGULAR PASSBAND

(75) Inventor: Jean-Michel Sajer, Audenge (FR)

Correspondence Address: Nixon Peabody LLP, P.O. Box 60610, Palo Alto, CA, 94306, US

(73) Assignee: COMMISSARIAT A L'ENERGIE ATOMIQUE ET AUX ENERGIES ALTERNATIVES, Paris (FR)

(21) Appl. No.: 12/746,919

(22) PCT Filed: Dec. 9, 2008
(86) PCT No.: PCT/EP08/67073

§ 371 Date: Jun. 8, 2010

(30) Foreign Application Priority Data
Dec. 11, 2007 (FR) 07 59724

(51) Int. Cl. G02B 27/46

(52) U.S. Cl. 359/559

(57) ABSTRACT

A spatial filtering device with narrow angular passband, characterized in that it comprises a photonic structure consisting of cylindrical elements distributed in the form of successive layers stacked along an axis Oz in a dielectric medium or in a vacuum, all the cylindrical elements being identical except for cylindrical elements of at least one layer consisting of cylindrical elements having a substantially smaller cross-sectional surface area than the cross-sectional area of the cylindrical elements of the layers surrounding it.

### CROSS REFERENCE TO RELATED APPLICATIONS OR PRIORITY CLAIM

This application is a national phase of International Application No. PCT/EP2008/067073, entitled “PHOTONIC DEVICE FOR SPATIAL FILTERING WITH NARROW ANGULAR PASSBAND”, which was filed on Dec. 9, 2008, and which claims priority of French Patent Application No. 07 59724, filed Dec. 11, 2007.

### DESCRIPTION

### Technical Field and Prior Art

The present invention relates to a device for spatially filtering electromagnetic waves with a narrow angular passband. The filtering device may be used from the range of radar frequencies (typically frequencies above 1 GHz) to frequencies of the optical domain.

The spatial filtering device of the invention may be used in very many applications which may be grouped by simplification into two main categories:
a first category relates to devices intended to purge light beams from parasitic spatial frequencies and, thus, to improve the detection quality of the signals (for example, improvement in the quality of the images in the field of imaging),
the second category relates to filtering devices used as screens (discrete radome, non-return filter, etc.).

Various spatial filtering devices are known from the prior art. In the optical field, the most common of them consists of forming with a lens the spatial spectrum of an object and of then filtering the latter with a diaphragm so as to only keep certain spatial frequencies. The angular width of the filtering around a given spatial frequency varies as the ratio of the aperture of the diaphragm to the focal length of the lens. Obtaining small filtering angular widths involves the use of diaphragms which are not very open, associated with lenses with important focal distances: the result is a bulky device which is difficult to align. In the case of filtering of intense laser beams, the previous device should further be placed in vacuo in order to avoid ionization of air in the vicinity of the diaphragm, the light intensity in this area being amplified by a factor of the order of the ratio of the section of the laser beam before focusing to that of the diaphragm.

Accordingly, the spatial filtering devices of the prior art are relatively bulky devices and difficult to adjust. The invention does not have these drawbacks.

### DISCUSSION OF THE INVENTION

Indeed, the invention relates to a spatial filtering device with a narrow angular passband characterized in that it comprises at least one photonic structure consisting of a set of cylindrical elements distributed in the form of successive layers stacked with a spatial period Tz along an axis Oz in a dielectric medium or in vacuo, the cylindrical elements consisting of a dielectric with a relative dielectric constant ∈₁ very substantially different from the relative dielectric constant ∈₂ of the dielectric medium, the cylindrical elements of a same layer having an axis parallel to an axis Oy and being aligned with a spatial period Tx along an axis Ox, the axes Oz, Oy and Ox defining a right trihedron, all the cylindrical elements having a substantially identical cross-sectional surface section in a same cross-sectional plane perpendicular to the axis Oy, except for cylindrical elements of at least one substitution layer which contains cylindrical substitution elements which have, in the cross-sectional plane, a cross-section with a substantially identical surface area, substantially smaller than the surface area of the cross-sections of the cylindrical elements of the layers surrounding it.

According to an additional feature of the invention, if ∈₁ is larger than ∈₂, the substitution elements have a relative dielectric constant ∈₃ which verifies the inequality:

1/5c₁/∈₁≦c₃/∈₃<1/2c₁/∈₁,

wherein c₁ is the proportion of a cross-sectional area of a cylindrical element centered in a first elementary pattern of section Tx×Tz relatively to the total surface area of the first pattern and c₃ is the proportion of a cross-sectional area of a cylindrical substitution element centered in a second elementary pattern of section Tx×Tz relatively to the total surface area of the second pattern.

According to another additional feature of the invention, if ∈₁ is less than ∈₂, the substitution elements have a relative dielectric constant ∈₃ which verifies the inequality:

1/5c₁/∈₁≦c₃/∈₃<1/2c₁/∈₁,

wherein c₁ is the proportion of a cross-sectional area of a cylindrical element centered in a first elementary pattern of section Tx×Tz relatively to the total surface area of the first pattern and c₃ is the proportion of a cross-sectional area of a cylindrical substitution element centered in a second elementary pattern of section Tx×Tz relatively to the total surface area of the second pattern.

According to still another additional feature of the invention, the material which makes up the cylindrical substitution elements is identical to the material which makes up the cylindrical elements.

According to still another additional feature of the invention, N sets of cylindrical elements are stacked along the axis 0z, two neighboring sets being separated by a dielectric layer.

According to still another additional feature of the invention, the thickness d₄ of the dielectric layer which separates two neighboring sets verifies the equation:

$${d}_{4} = \frac{{λ}_{4}}{2 \sqrt{( 1 - {( sin ( {i}_{p} ) / {n}_{4} )}^{2}}} ( K + \frac{1}{4} )$$

wherein:

λ₄ is the wavelength of the wave which propagates in the dielectric layer,

n₄ is the refractive index of the dielectric layer,

iₚ is a particular incidence (i.e. a particular angle of incidence) around which is defined a forbidden angular band for a photonic structure exclusively made up from cylindrical elements distributed in a dielectric medium or in vacuo according to the photonic structure of claim 1,

K is an integer larger than or equal to 1.

According to still another additional feature of the invention, the cylindrical elements and the cylindrical substitution elements have a circular cross-section.

According to still another additional feature of the invention, the periods Tz and Tx are equal.

According to still another additional feature of the invention, the periods Tz and Tx are equal to 0.4 times the wavelength of the wave in the dielectric medium.

According to still another additional feature of the invention, the radius of the circular cross-section of the cylindrical substitution elements is substantially equal to 0.05 Tx and the radius of the cylindrical elements is substantially equal to 0.15 Tx.

With the present invention it is possible to obtain spatial filtering with a very small angular width by means of a planar multilayer structure, the total thickness of which is for example of the order of a few tens of wavelengths. This filtering does not require any vacuum since there is no need to ensure focusing and is based on a simple alignment relatively to the direction of propagation of the wave to be filtered.

### SHORT DESCRIPTION OF THE FIGURES

Other features and advantages of the invention will become apparent upon reading a preferential embodiment made with reference to the appended figures, wherein:

FIG. 1 illustrates a first exemplary photonic structure with a forbidden angular band used for making a spatial filtering device according to the invention;

FIGS. 2A and 2B respectively illustrate a second and a third exemplary photonic structure with a forbidden angular band used for making a spatial filtering device according to the invention;

FIG. 3 illustrates a first exemplary spatial filtering device of the invention which uses the structure of FIG. 1;

FIG. 4 illustrates a second exemplary spatial filtering device of the invention which uses the structure of FIG. 1;

FIG. 5 illustrates a third exemplary spatial filtering device of the invention which uses the structure of FIG. 1;

FIG. 6 illustrates the transmission coefficient of the spatial filtering device of the invention illustrated in FIG. 3;

FIG. 7 illustrates the respective transmission coefficients of the spatial filtering devices of the invention illustrated in FIGS. 4 and 5;

FIG. 8 illustrates a zoomed view of the transmission coefficients of the spatial filtering devices of the invention illustrated in FIGS. 4, 5 and 6.

### DETAILED DESCRIPTION OF EMBODIMENTS OF THE INVENTION

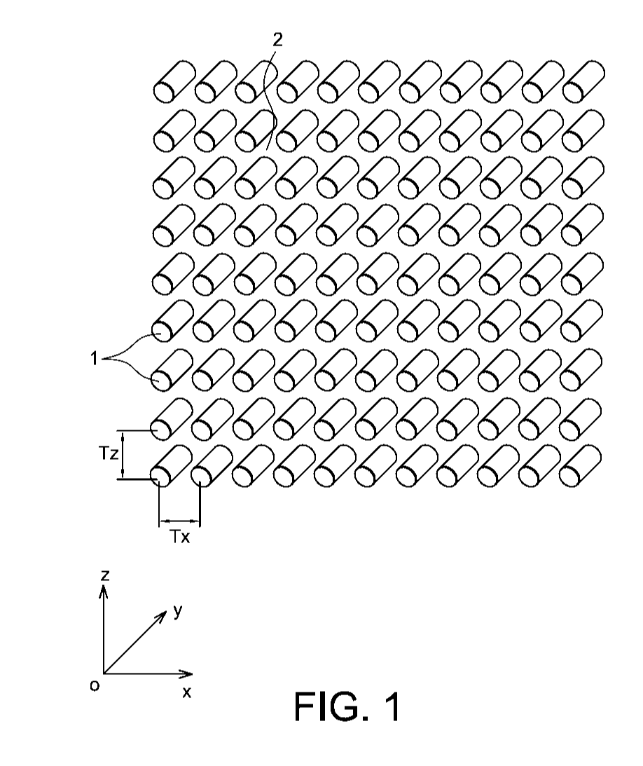

FIG. 1 illustrates an exemplary photonic structure with a forbidden angular band which is used for making a spatial filtering device in accordance with the invention.

The photonic structure with a forbidden angular band is made of a periodic juxtaposition of identical dielectric elements 1 placed in a medium 2. The medium 2 is a dielectric medium or the vacuum. The elements 1 have, for example, a cylindrical shape, and are positioned parallel to each other. The cylindrical elements 1 are distributed in successive layers parallel to an xOy plane and stacked, with period Tz, along an axis Oz perpendicular to the xOy plane. The reference system xyz forms a right trihedron. The cylindrical elements 1 of a same layer have a spatial period Yx along the axis Ox. The axes of the cylindrical elements 1 are parallel to the Oy axes. The cylinders for example have a circular transverse section, any other shape of transverse section may also be contemplated (square, rectangular, polygonal, etc.). Typically the spatial periods Tx and Tz are less than the wavelength λ of the electromagnetic wave which propagates in the dielectric medium 2 in order to avoid excitation of propagation modes (Bloch modes) other than the fundamental mode.

For a sufficiently large difference between the relative dielectric permittivity c of the cylindrical elements 1 and the relative dielectric permittivity ∈₂ of the medium 2, the structure has a forbidden angular incidence band. The <<forbidden angular incidence band>> is, by definition, an angular aperture such that any incident wave coming on the structure with an incidence angle comprised in this angular aperture cannot propagate in the structure. As this is known to one skilled in the art, the angle of incidence of a wave on a planar structure is, by definition, the angle formed by the wave vector of the wave with the normal to the plane of the structure.

As a non-limiting example, for a ratio ∈₂/∈₁ substantially larger than 2.5, the forbidden angular band is obtained for an electromagnetic wave polarized in the xOz plane and, for a ratio ∈₁/∈₂ substantially larger than 2.5, the forbidden angular band is obtained for a wave polarized along the Oy axis. Any planar electronic wave having an incidence comprised in the forbidden angular band is reflected and therefore cannot propagate. A stack of about ten layers of elements 1 in the propagation direction Oz is sufficient for creating very performing forbidden angular bands for a wave polarized along the Oy axis.

As a non-limiting example, when the medium 2 is the vacuum, the relative permittivity of the elements 1 is equal to 8.41 and the periods Tx and Tz are equal to 0.4 times the wavelength λ of a propagating wave. In the particular case when the transverse section of the cylinder elements 1 forms a circle, the radius of this circle is equal to 0.15 times the periods Tx and Tz.

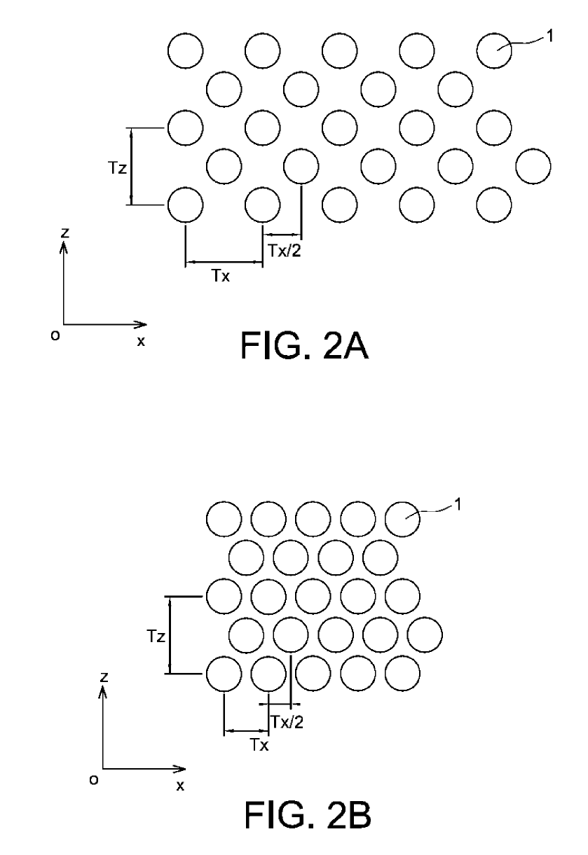

In FIG. 1, the cylindrical elements 1 of two successive layers of cylindrical elements are aligned on the Oz axis. Other configurations are however possible wherein the cylindrical elements 1 of two successive layers are not aligned along the Oz axis. As non-limiting examples, FIGS. 2A and 2B illustrate these other configurations. FIGS. 2A and 2B are cross-sectional views. The elements 1 of two neighboring layers are not aligned along the Oz axis. In FIG. 2A, three successive stacked layers of elements 1 form a pattern, an elementary cell of which in the xOz plane is a centered square cell and, in FIG. 2B, three successive layers of elements 1 form a pattern, an elementary cell of which in the xOz plane is a hexagonal cell.

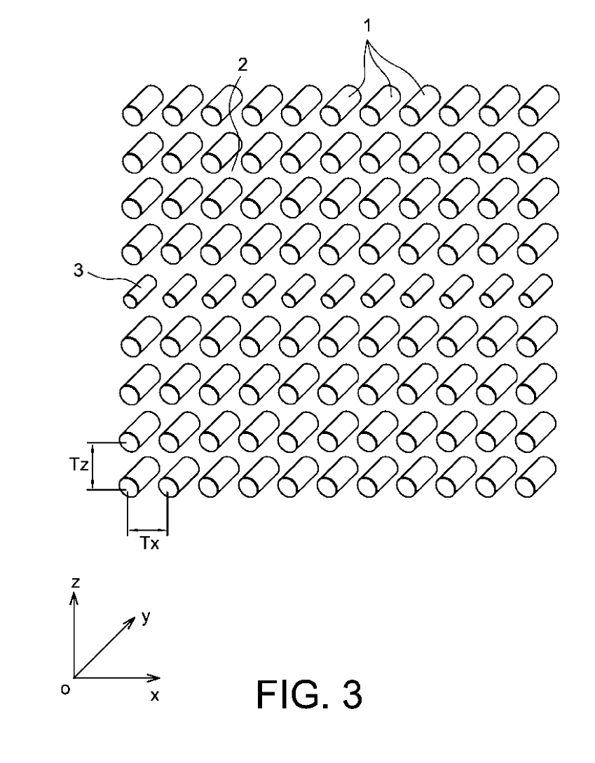

FIG. 3 illustrates a first exemplary elementary spatial filtering device structure of the invention which uses the structure of FIG. 1.

The spatial filtering device of the invention is obtained by substitution of at least one layer of cylindrical elements 1 with at least one layer of cylindrical substitution elements 3. The cylindrical substitution elements 3 have a cross-section in the plane xOz with a surface area substantially smaller than the surface area of the cross-section of the cylindrical elements 1. FIG. 2 illustrates the non-limiting case where a single layer of elements 1 is replaced with a single layer of substitution elements 3 located at the centre of the structure. Other configurations are however possible in which N layers of substitution elements 3 replace N layers of elements 1, the layers of substitution elements may either be placed in the centre of the device or not. The substitution elements 3 for example have a circular cross-section, any other shape of cross-section may also be contemplated (square, rectangular, polygonal, etc.). The substitution elements 3 are formed in a dielectric material which may be identical or different from the material which forms the elements 1. The presence of the cylindrical substitution elements 3 in the structure with a forbidden angular band leads to the <<piercing>> of the forbidden angular band. By <<piercing>> the forbidden angular band, it should be understood that an electromagnetic wave for which the angle of incidence is comprised in the forbidden angular band manages to propagate in the structure. The electromagnetic wave which then propagates in the structure only propagates in a very small angular domain around a particular incidence. Within the scope of the numerical example given earlier (Tx=Tz=0.4λ and a radius of the circular cross-section of a cylindrical element 1 equal to 0.15 Tx) the substitution elements 3 are cylinders with a circular cross-section, the radius of which is for example equal to 0.05 Tx.

For a given photonic structure, the existence and the value of the particular incidence are conditioned by an average relative permittivity value ∈ₘ such that:

∈ₘ=c₃∈₃+c₂∈₂

wherein:

c₃ is the proportion of the cross-sectional area of a substitution element 3 centered in an elementary pattern of section Tx×Tz relatively to the total surface area Tx×Tz of the pattern, and

c₂ in said pattern is the proportion of the surface area formed by the material 2 relatively to the total surface area Tx×Tz of the pattern (c₂+c₃=1).

Different experiments have shown that, in the case when for example, ∈₁>∈₂, the conditions for occurrence of the <<piercing>> of the forbidden area exist if the following inequality is verified:

1/5(c₁∈₁)≦c₃∈₃<1/2(c₁∈₁)

wherein:

c₁ is the proportion of the cross-sectional area of a cylindrical element 1 centered in an elementary pattern of section Tx×Tz relatively to the total surface area Tx×Tz of the pattern, and

c₃ is the proportion mentioned above.

The increase of ∈ₘ due to an increase of the amount c₃∈₃ leads to a displacement of the particular incidence towards high incidences. In the case when for example ∈₁<∈₂, the previous remarks are valid provided that the terms ∈ᵢ (i=1,3) are replaced with 1/∈ᵢ in all the expressions.

According to a particularly advantageous embodiment of the invention, for particular characteristics of the substitution elements defined earlier, there exists a value of the angle of incidence for which transmission is substantially equal to one, the width of the transmission window around this particular incidence being of the order of a few hundredths of radians. Within the scope of the numerical example given earlier, the width of the transmission window is of a few hundredths of radians around a particular incidence substantially equal to 42° (i.e. the angle of incidence of the wave on the photonic device is substantially equal to 42°).

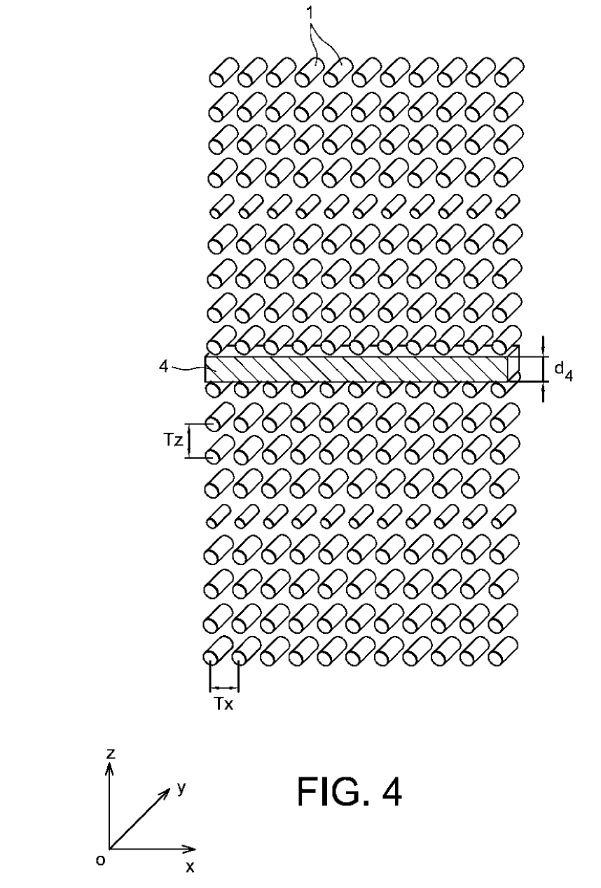

FIG. 4 illustrates a second exemplary spatial filtering device of the invention which uses the structure of FIG. 1.

The device illustrated in FIG. 4 consists of two devices identical with the one illustrated in FIG. 3. Both devices are stacked along the Oz axis. A dielectric layer 4 separates both devices. In the case when the layer 4 has a thickness of less than 2 Tx, the cylindrical elements aligned along the Oz axis of a first device are preferentially aligned with the cylindrical elements aligned along the axis Oz of the second device. For a thickness of the layer 4 larger than or equal to 2 Tx, it is not necessary that the alignments along the axis Oz of the cylindrical elements of both devices coincide.

Generally, the thickness of the layer 4 verifies the following equation:

$${d}_{4} = \frac{{λ}_{4}}{2 \sqrt{( 1 - {( sin ( {i}_{p} ) / {n}_{4} )}^{2}}} ( K + \frac{1}{4} )$$

wherein:

λ₄ is the wavelength of the wave which propagates in the layer 4,

n₄ is the refractive index of the layer 4,

iₚ is the particular incidence (i.e. the particular angle of incidence) around which the forbidden angular band is defined for the photonic structure with a forbidden angular band from which the photonic structure of the invention is defined,

K is an integer larger than or equal to 1.

The dielectric which forms the layer 4 may be any dielectric as long as the equation above is properly verified. Preferentially, it is the dielectric used for producing the medium 2 which is also used for producing the layer 4. If the medium 2 is a vacuum, the layer 4 may therefore also be a vacuum.

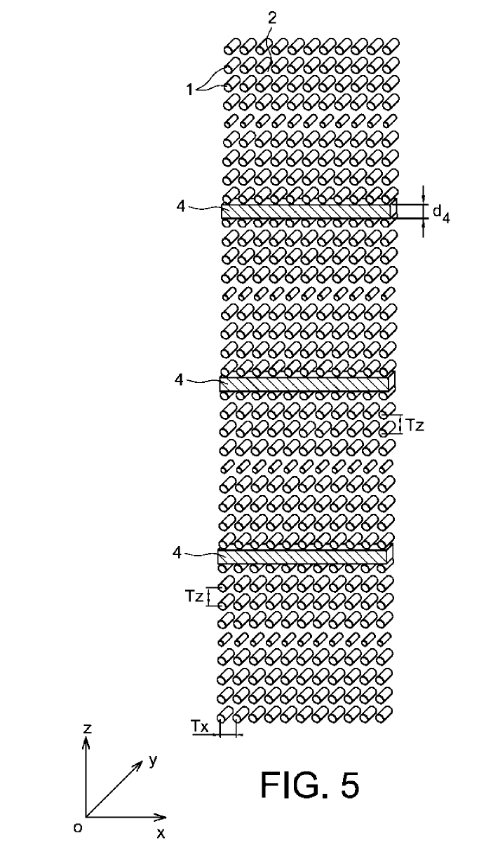

The device illustrated in FIG. 5 consists of four devices identical with the one illustrated in FIG. 3. The four devices are superposed, a dielectric layer 4 separating both neighboring devices. The conditions mentioned above for the device of two stacked devices, i.e. the alignment of the cylindrical elements along the Oz axis, the thickness and the nature of the dielectric which forms the layer 4, are also produced for the device with four stacked devices. The performances of the structure with four filtering devices are improved very substantially relatively to the performances of structures with a single device or two devices.

More generally, the transmission coefficient of N stacked elementary filtering devices varies as the N^{th} power of the transmission coefficient of an elementary filtering device.

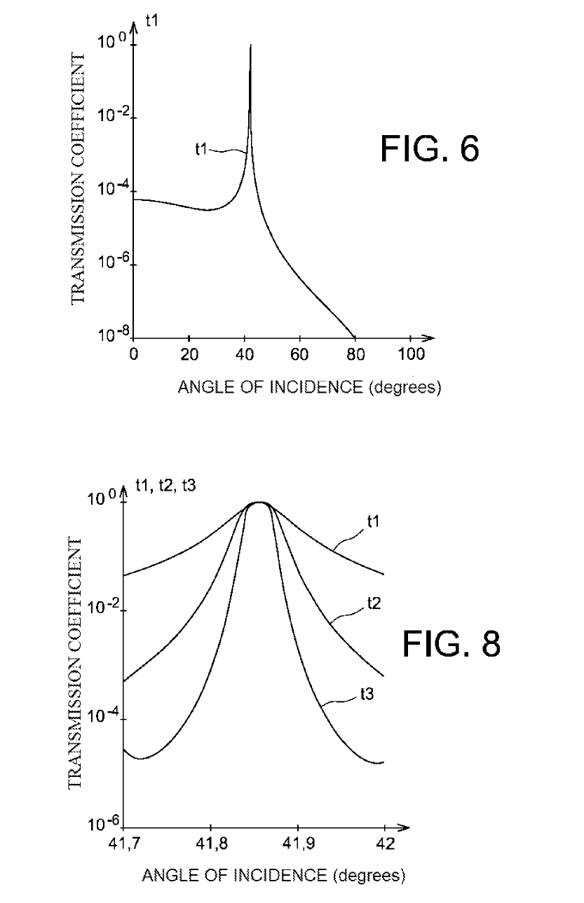

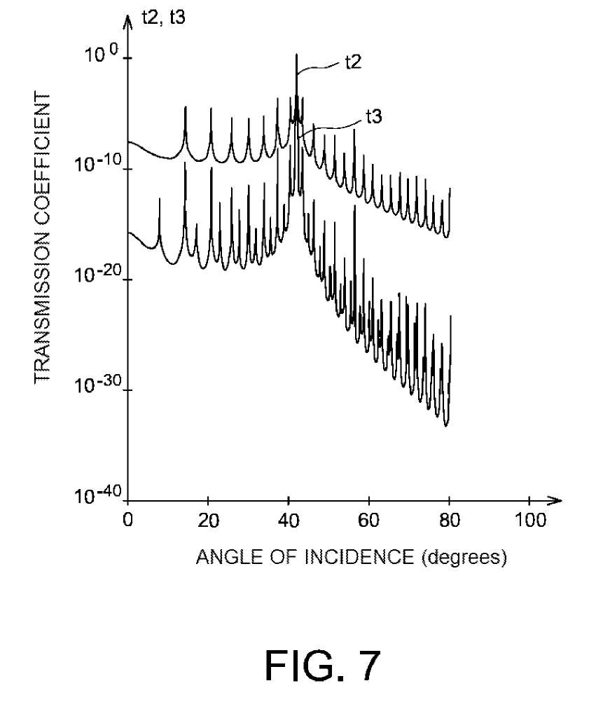

FIGS. 6, 7 and 8 illustrate the transmission coefficients of the device of the invention described earlier. FIG. 6 illustrates the transmission coefficient t1 of the filtering device of the invention illustrated in FIG. 3 versus the angle of incidence of the electromagnetic wave and FIG. 7 illustrates the transmission coefficients t2 and t3 of the filtering devices of the invention respectively illustrated in FIGS. 4 and 5.

FIG. 8 details FIGS. 6 and 7 around the maximum value of the transmission coefficients. It is clearly apparent that a structure with four devices has better performances than a structure with two devices, the performances of which are themselves better than the performances of a structure with a single device.

1. A spatial filtering device with a narrow angular passband, characterized in that it comprises at least one photonic structure consisting of a set of cylindrical elements distributed as successive layers with a spatial period Tz stacked along an axis Oz in a dielectric medium or in vacuo, the cylindrical elements consisting of a dielectric of a relative dielectric constant ∈₁ very substantially different from the relative dielectric constant ∈₂ of the dielectric medium, the cylindrical elements of a same layer having an axis parallel to the Oy axis and being aligned with a spatial period Tx along an axis Ox, the axes Oz, Oy and Ox defining a right trihedron, all the cylindrical elements having a substantially identical cross-sectional surface in a same cross-sectional plane perpendicular to the axis Oy, except for cylindrical elements of at least one substitution layer which contains cylindrical substitution elements which have, in the cross-sectional plane, a cross-sectional surface area substantially identical, substantially smaller than the surface area of the cross-sections of the cylindrical elements of the layers surrounding it.

2. The device according to claim 1 wherein, if ∈₁ is larger than ∈₂, the substitution elements have a relative dielectric constant ∈₃ which verifies the inequality:
1/5c₁/∈₁≦c₃/∈₃<1/2c₁/∈₁,
wherein c₁ is the proportion of a cross-sectional area of a cylindrical element centered in a first elementary pattern with section Tx×Tz relatively to the total surface area of the first pattern and c₃ is the proportion of a cross-sectional area of a cylindrical substitution element centered in a second elementary pattern with section Tx×Tz relatively to the total surface area of the second pattern.

3. The device according to claim 1, wherein, if ∈₁ is less than ∈₂, the substitution elements have a relative dielectric constant ∈₃ which verifies the inequality:
1/5c₁/∈₁≦c₃/∈₃<1/2c₁/∈₁,
wherein c₁ is the proportion of a cross-sectional area of a cylindrical element centered in a first elementary pattern of section Tx×Tz relatively to the total surface area of the first pattern and c₃ is the proportion of a cross-sectional area of a cylindrical substitution element centered in a second elementary pattern of section Tx×Tz relatively to the total surface area of the second pattern.

4. The device according to claim 1, wherein the material which makes up the cylindrical substitution elements is identical with the material which makes up the cylindrical elements.

5. The device according to claim 1 and which comprises N sets of stacked cylindrical elements along the axis Oz, two neighboring sets being separated by a dielectric layer.

6. The device according to claim 5, wherein the thickness d₄ of the dielectric layer which separates two neighboring sets verifies the equation:
$${d}_{4} = \frac{{λ}_{4}}{2 \sqrt{( 1 - {( sin ( {i}_{p} ) / {n}_{4} )}^{2}}} ( K + \frac{1}{4} )$$
wherein:
λ₄ is the wavelength of the wave which propagates in the dielectric layer,
n₄ is the refractive index of the dielectric layer,
iₚ is a particular incidence (i.e. a particular angle of incidence) around which is defined a forbidden angular band for a photonic structure exclusively consisting of cylindrical elements distributed in a dielectric medium or in a vacuum according to the photonic structure of claim 1,
K is an integer larger than or equal to 1.

7. The device according to claim 1, wherein the cylindrical elements and the cylindrical substitution elements have a circular cross-section.

8. The device according to claim 1, wherein the periods Tz and Tx are equal.

9. The device according to claim 8, wherein the periods Tz and Tx are equal to 0.4 times the wavelength of the wave in the dielectric medium.

10. The device according to claim 7, wherein the radius of the circular cross-section of the cylindrical substitution elements is substantially equal to 0.05 Tx and the radius of the cylindrical elements is substantially equal to 0.15 Tx.
